(19) United States
(12) Patent Application Publication
(10) Pub. No.: US 2013/0318432 A1
(43) Pub. Date: Nov. 28, 2013

(54) METHOD AND SYSTEM TO DYNAMICALLY RENDER SERVICES FOR MULTIPLE CHANNELS

(71) Applicant: Infosys Limited, Bangalore (IN)

(72) Inventors: Puneet Gupta, Bangalore (IN); Venkat Kumar Sivaramamurthy, Bangalore (IN); Karthik Gopalakrishnan Vinmani, Bangalore (IN)

(73) Assignee: Infosys Limited, Bangalore (IN)

(21) Appl. No.: 13/900,411

(22) Filed: May 22, 2013

(30) Foreign Application Priority Data
May 23, 2012 (IN) 2051/CHE/2012

(51) Int. Cl. G06F 17/22

(52) U.S. Cl. CPC G06F 17/2247
USPC 715/234

(57) ABSTRACT

The present invention discloses a method to dynamically render a service for multiple channels based on predefined user specification. The method comprises registering user specification such as choice of the one or more services, format of each service, preferred channel of each service, content of each service, and level of security for each service selected by the user at a centralized portal. The method further comprises identifying, for every subsequent user login, user details comprising type of the user device, channel accessed by the user device, time of access, and bandwidth available for the channel. Additionally, the method comprises fetching the user specifications for each service to be rendered based on the identified user details and dynamically rendering the one or more services on a user device with the user specifications.

### FIELD

The invention relates generally to the field of dynamic web service configuration. In particular, the invention relates to a method and system for dynamically rendering a web service based on predefined user configuration.

### BACKGROUND

The evolution of the web is going through a phase where the number of available avenues to access it is on a perpetual rise. This has led to organizations not only changing their business processes but also their business models—real-time integration of processes and services both within and between enterprises is the order of the day. Many new software products and services are designed and developed from the outset to be delivered as web services because of the availability of various channels. With ever-changing business requirements and popularity of service-oriented computing technologies, the users have a plethora of options for what they want and how they want it. This calls in for enhancement of the web services in order to accommodate the user preferences.

The current web services offer user configuration and customization mostly at the user interface level. However, there exists no solution to meet the diversity of end-user requirements by involving the user in the end-to-end rendering of a service.

Thus, in light of the foregoing discussion, there is a need for a method and a system that will dynamically render a service on a user device based on predefined user configuration.

### SUMMARY

The present invention discloses a method to dynamically render a service for multiple channels based on predefined user specification. The method comprises registering user specification such as choice of the one or more services, format of each service, preferred channel of each service, content of each service, and level of security for each service selected by the user at a centralized portal. The method further comprises identifying, for every subsequent user login, user details comprising type of the user device, channel accessed by the user device, time of access, and bandwidth available for the channel. Additionally, the method comprises fetching the user specifications for each service to be rendered based on the identified user details and dynamically rendering the one or more services on a user device with the user specifications.

The present invention relates to a system to dynamically render a service for multiple channels based on predefined user specification. The system comprises a centralized portal to register user specifications comprising choice of the one or more services, format of each service, preferred channel of each service, content of each service, and level of security for each service selected by the user. The system further comprises a server that has an identification module, a configuration module and a rendering module. The identification module identifies user details comprising type of the user device, channel accessed by the user device, time of access, and bandwidth available for the channel. The configuration module fetches the user specification based on the identified user details and configures each of the services to be rendered based on the user specification. The rendering module dynamically renders the service requested by the user on the user device based on the user specification.

### DRAWINGS

FIG. 1 is a flowchart describing a method for registering a user and accepting user configuration for list of required services;

FIG. 2 is a flowchart describing a method for dynamically rendering a service to the user based on predefined user configuration;

FIG. 3 is a block diagram describing a system for dynamically rendering a service to the user based on predefined user configuration;

FIG. 4 illustrates a generalized example of a computing environment 400.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

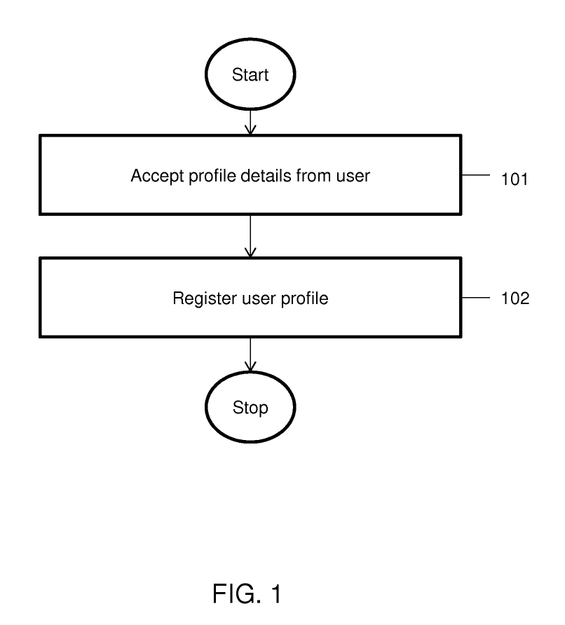

FIG. 1 is a flow chart describing a method to register a user at a centralized portal for dynamic rendering of customized services. At step 101, profile details and specifications of a user are accepted at the centralized portal. In an embodiment, the profile details of a user comprise login credentials and other details such as address, phone number, and the like of the user. The user specifications may include one or more preferred services and a preferred format, channel, content and security level for each of the services. Further, as used herein, the format refers to a service workflow that is made up of multiple pages with each page having content, layout(s) and style sheet(s) as configured by the user. Furthermore, the content may be text, audio, video, animation or a combination of these. At step 102, the profile details and specifications of the user are saved and the user is registered with the application.

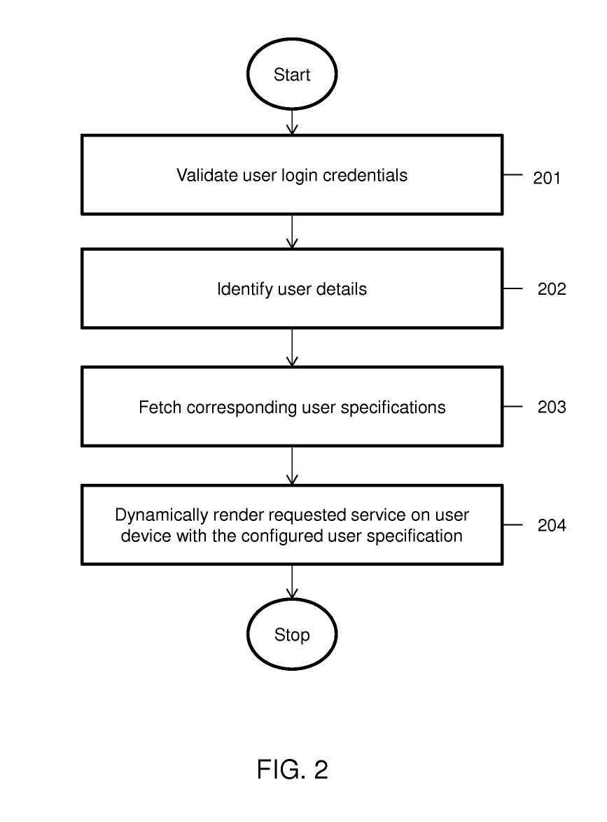

FIG. 2 is a flow chart describing a method to dynamically render a requested service with user configuration. At step 201, the user credentials are validated and the user logs into the application. It should be noted that other parameters including the internet protocol (IP) address of the user device, cookies and the like may also be used for user login. At step 202, the user details are identified by the application. In an embodiment, the user details include the device used by the user, which may be a desktop computer, a laptop computer, a handheld device, a wireless device and in general any device with input, processing and display capabilities, channel accessed by the user device such as 2G, 3G and the like., time of access and bandwidth available for the channel. At step 203, the application fetches the specifications configured by the user at the time of registration corresponding to the identified user details. At step 204, the requested service is rendered on the user device with the preferred user specifications. As used herein, the term rendering includes creation and generation of the service. In an embodiment, the service may be rendered on a thin client. It should be noted that the service may be rendered on other types of clients as well.

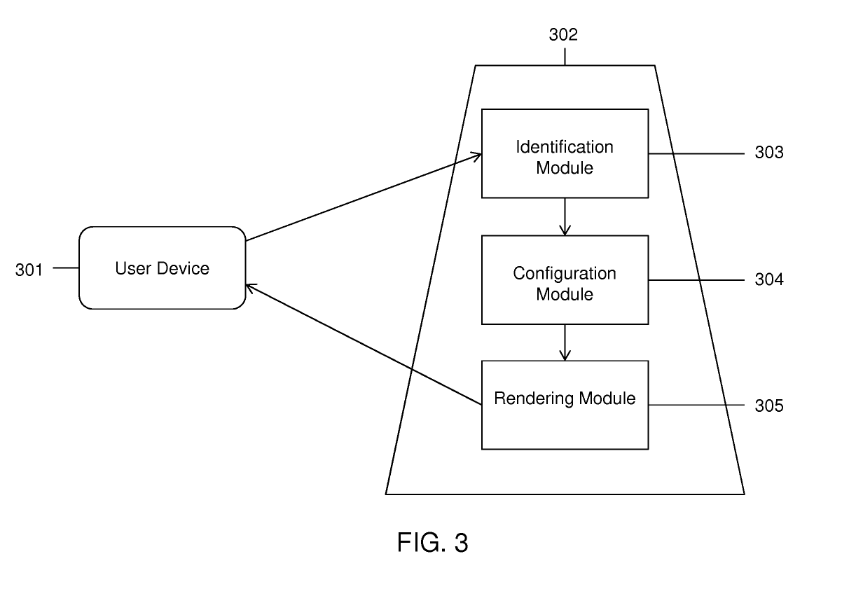

FIG. 3 is a diagram depicting a system to dynamically render a service with user configuration. FIG. 3 includes a user device 301 that generates a request for a service. The service request is received at an application server 302. Application server 302 further includes an identification module 303, a configuration module 304 and a rendering module 305. In accordance with various embodiments, identification module 303 identifies user information such as the type of user device (desktop, laptop, mobile phone, PDA, etc.), the channel accessed by the user device, bandwidth available for the channel and time of access. This user information is passed on to configuration module 304, which fetches the user configuration corresponding to the requested service and user information. The user configuration is further passed on to rendering module 305 that renders the service on the user device with the required user configuration.

In an embodiment, the user may request for a banking service, say, a “Banking Transaction” service. Once the user logs in to the application, the application identifies the user details, such as a mobile device with a 2G connection, requesting for accessing at 20:00 hours. The application fetches the user specifications for the Banking Transaction service. The user specifications may include a template T having text content, a security level for allowing transaction only before 21:00 hours and an e-mail summary of the transaction to a particular e-mail address. After validating that the time of access is earlier than 21:00 hours, the application dynamically creates webpages with the template T and only the text content for the Banking Transaction service on the mobile device accessed by the user. After the transaction is complete, the application sends an e-mail summary of the transaction to the specified e-mail address.

### Exemplary Computing Environment

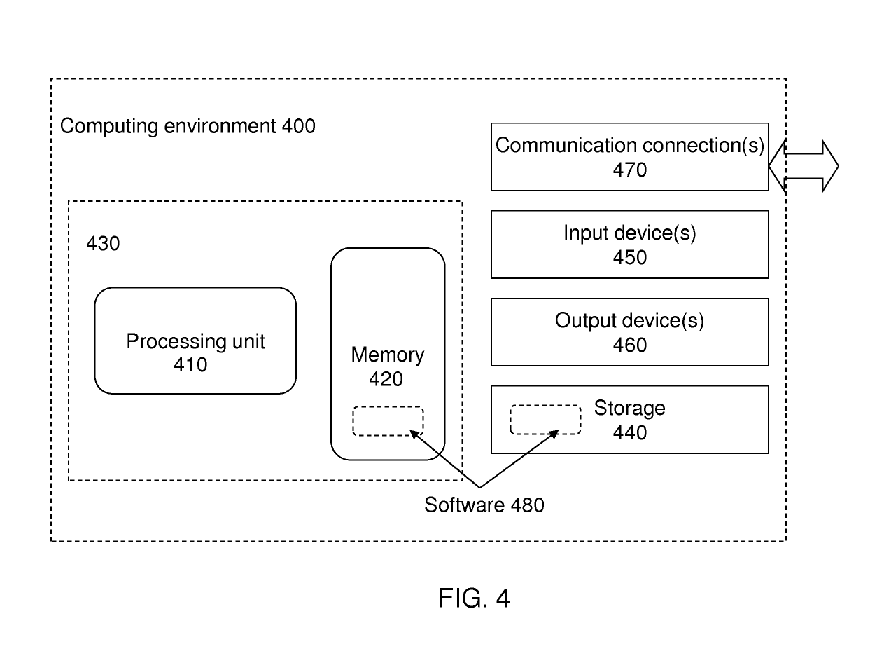

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer-implemented method executed by one or more computing devices to dynamically render one or more services for multiple channels, comprising:
registering, at a centralized portal, user specifications comprising choice of the one or more services, format of each service, preferred channel of each service, content of each service, and level of security for each service selected by the user;
for every subsequent user login through a user device, identifying user details comprising type of the user device, channel accessed by the user device, time of access, and bandwidth available for the channel;
fetching the user specifications for each service to be rendered based on the identified user details; and
dynamically rendering the one or more services on a user device with the user specifications.

2. The method of claim 1, wherein each of the one or more services comprises at least one workflow.

3. The method of claim 2, wherein each workflow comprises one or more pages.

4. The method of claim 3, wherein each of the one or more pages comprises one of at least one layout and at least one style sheet.

5. The method of claim 1, wherein the content of each service comprises text, audio, video and animation.

6. The method of claim 1, wherein the type of the user device comprises a device with input, processing and display capabilities.

7. The method of claim 1, wherein the channel accessed by the user device comprises a data access channel.

8. A system to dynamically render one or more services for multiple channels, comprising:
a centralized portal to register user specifications comprising choice of the one or more services, format of each service, preferred channel of each service, content of each service, and level of security for each service selected by the user;
a server comprising:
an identification module to identify, for every user login through a user device, user details comprising type of the user device, channel accessed by the user device, time of access, and bandwidth available for the channel;
a configuration module to
fetch user specifications from the centralized portal and the identified user details; and
configure each service to be rendered with the user specifications based on the identified user details; and
a rendering module to dynamically render the one or more configured services on a user device.

9. The system of claim 8, wherein each of the one or more services comprises atleast one workflow.

10. The system of claim 9, wherein each workflow comprises one or more pages.

11. The system of claim 10, wherein each of the one or more pages comprises one of at least one layout and at least one style sheet.

12. The system of claim 8, wherein the content of each service comprises text, audio, video and animation.

13. The system of claim 8, wherein the type of the user device comprises a device with input, processing and display capabilities.

14. The system of claim 8, wherein the channel accessed by the user device comprises a data access channel.

15. A computer program product for use with a computer, the computer program product comprising a computer readable medium having computer readable program code embodied therein for dynamically rendering one or more services for multiple channels, the computer readable program code storing a set of instructions configured for:
registering, at a centralized portal, user specifications comprising choice of the one or more services, format of each service, preferred channel of each service, content of each service, and level of security for each service selected by the user;
for every subsequent user login through a user device, identifying user details comprising type of the user device, channel accessed by the user device, time of access, and bandwidth available for the channel;
fetching the user specifications for each service to be rendered based on the identified user details; and
dynamically rendering the one or more services on a user device with the user specifications.
